(19) United States
(12) Patent Application Publication
(10) Pub. No.: US 2009/0286519 A1
(43) Pub. Date: Nov. 19, 2009

(54) METHOD FOR MOBILE TERMINAL RECEIVING MBMS SERVICE AND MBMS SERVICE TRANSMITTING SYSTEM

(75) Inventors: Yaying WANG, Shenzhen (CN); Wei Ma, Shenzhen (CN)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ZTE CORPORATION, Shenzhen (CN)

(21) Appl. No.: 12/511,079

(22) Filed: Jul. 29, 2009

Related U.S. Application Data
(63) Continuation-in-part of application No. PCT/CN2008/000148, filed on Jan. 21, 2008.

(30) Foreign Application Priority Data
Jan. 29, 2007 (CN) 200710006080.1

(51) Int. Cl. H04M 3/42; H04B 17/00

(52) U.S. Cl. 455/414.1; 455/67.11

(57) ABSTRACT

The present invention discloses a method of a mobile terminal receiving MBMS service and a detection method of the mobile terminal receiving MBMS service data, and a MBMS service transmitting system. Wherein, the method of receiving MBMS service includes the steps as follows: S102, informing a mobile terminal the start of an MBMS session by a system simulator; S104, transmitting the MBMS MODIFICATION SERVICE MESSAGE to the system simulator via a dedicated control channel DCCH by the mobile terminal to request the system simulator to establish a wireless service channel for point-to-point transmitting, the MBMS modified service information comprises information element; S106, establishing the wireless service channel between the system simulator and the mobile terminal; S108, receiving MBMS service data transmitted by the system simulator via the wireless service channel by the mobile terminal. The present invention can test and verify the MBMS service ability of the mobile terminal properly.

### FIELD OF THE INVENTION

The present invention relates to communication field, in particular to a method and a system for a mobile terminal receiving MBMS service, and a test method for the mobile terminal receiving MBMS service data.

### BACKGROUND OF THE INVENTION

Mobile phone television is one of the primary services of the third generation mobile communication technology, for which different realization mode technologies have been brought into view in the industry. The main mobile phone television technologies at present mainly comprise DVB-H (Digital Video Broadcasting Handheld), DMB (Digital Multimedia Broadcasting) and MBMS (Multimedia Broadcast/Multicast Service). Among the three technologies, MBMS has the advantages of having no need of adding ground broadcasting device and adding wireless receiving module to the terminal compared with the other two technologies. Therefore, MBMS technology has better utilization prospect and promising market in mobile phone television field than the other two technologies.

In MBMS technology, the main user data transmission channel for transmitting services comprises MTCH (MBMS point-to-multipoint Traffic Channel) and DTCH (Dedicated Traffic Channel). The terminal can notify to start receiving MBMS service by initiatively request to communicate with SS (system simulator). In the circumstances that the terminal being in different connection states, SS can notify the terminal to start receiving MBMS service via different logic channels.

### SUMMARY OF THE PRESENT INVENTION

The present invention aims to provide a method for the mobile terminal receiving EMS service, a detection method for the mobile terminal receiving MBMS service data and a MBMS service transmitting system.

The method of the mobile terminal receiving MBMS service based on the present invention includes the steps as follows: S102, informing a mobile terminal the start of an MBMS Session by a system simulator; S104, transmitting MBMS MODIFIED SERVICE MESSAGE to the system simulator via a dedicated control channel DCCH by the mobile terminal to request the system simulator to establish a wireless service channel for point-to-point transmitting, the MBMS MODIFIED SERVICE MESSAGE comprises information element; S106, establishing the wireless service channel between the system simulator and the mobile terminal; S108, receiving MBMS service data transmitted by the system simulator via the wireless service channel by the mobile terminal.

The detection method of the mobile terminal to start an MBMS Session based on the present invention includes the steps as follows, S202, a mobile terminal entering dedicated traffic channel state; S204, informing the mobile terminal the start of an MBMS session by a system simulator; S206, establishing wireless service channel between the system simulator and the mobile terminal; S208, Finishing the establishment of the wireless service channel between the system simulator and the mobile terminal; S210, detecting the state of the mobile terminal, ensuring that the mobile terminal is in dedicated traffic channel state.

The MBMS service transmitting system based on the present invention comprises a system simulator, used for establishing wireless service channel between a mobile terminal and itself, and transmitting MBMS service data to the mobile terminal via the wireless service channel detecting the state of the mobile terminal and ensuring the mobile terminal is in dedicated traffic channel state; and the mobile terminal, used for establishing the wireless service channel between the system simulator and itself, and receiving the MBMS service data transmitted by the system simulator via the wireless service channel.

The method provided by the present invention is easy and practical, and can test and verify the MBMS service ability of the mobile terminal properly.

### BRIEF DESCRIPTION OF THE DRAWINGS

The drawings described herein are provided for further understanding the present invention, constitute a part of the present application. The exemplary embodiments of the present invention and the explanation thereof are given by way of illustration only, and thus are not limitative of the present invention, and wherein:

FIG. 1 is a flow chart of the method for a mobile terminal receiving MBMS service according to the embodiment of the present invention;

FIG. 2 is a flow chart of the test method for a mobile terminal receiving MBMS service data according to the embodiment of the present invention;

FIG. 3 is a block diagram of the MBMS service transmitting system according to the embodiment of the present invention.

### DETAILED DESCRIPTION

The embodiments of the present invention will be described in detail with reference to the accompanying drawings, wherein if not conflict, the embodiments and the technical features thereof can be combined.

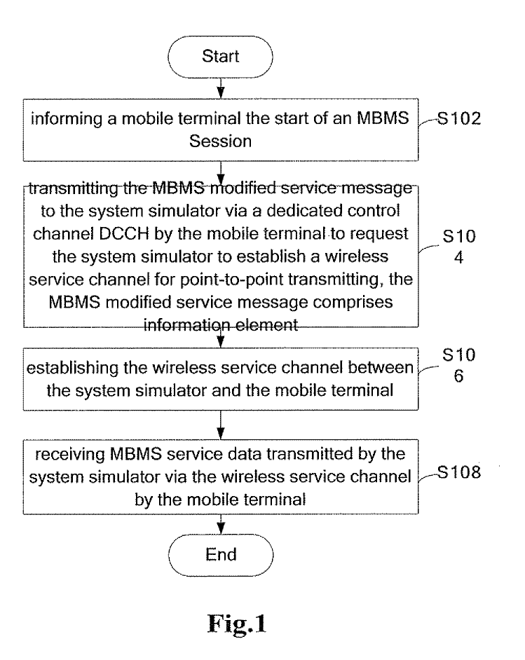

FIG. 1 shows the method for a mobile terminal receiving MBMS service according to the embodiment of the present invention. As shown in FIG. 1, the method includes the steps as follows: S102, the SS informing the mobile terminal the start of an MBMS Session; S104, transmitting the MBMS MODIFIED SERVICE MESSAGE to the system simulator via a dedicated control channel DCCH by the mobile terminal to request the system simulator to establish a wireless service channel for point-to-point transmitting, the MBMS MODIFIED SERVICE MESSAGE comprises information element; S106, establishing the wireless service channel between the SS and the mobile terminal; and S108, the mobile terminal receiving the MBMS service data transmitted by the SS via the wireless service channel.

Hereafter, taking the circumstance that the mobile terminal being in CELL_DCH state as an example, the method how the SS notifies the mobile terminal to start to receive the MBMS service transmitted in PTP mode will be explained. When the mobile terminal is in CELL_DCH state, the specific steps of the SS notifying the mobile terminal to start to receive the MBMS service transmitted in PTP mode includes:

1) The SS transmits the MBMS MODIFIED SERVICE MESSAGE to the mobile terminal via the DCCH. Wherein, the information element “MBMS required UE action” in the information is set as “Request PTP RB”.

2) After receiving the MBMS MODIFIED SERVICE MESSAGE, according to the setting of the information element in the Message, the mobile terminal sends a MBMS MODIFICATION REQUEST Message to the SS to request to establish the RB required by service transmission.

3) After receiving the service request message (e.g. MBMS MODIFICATION REQUEST), the SS sends a RADIO BEARER SETUP Message to the mobile terminal to notify the terminal to establish the RB.

4) After establishing the RB between the mobile terminal and the SS, the mobile terminal sends a RADIO BEARER SETUP COMPLETE Message to notify the SS that the RB is successfully established.

5) The SS sends user data to the mobile terminal through the newly established RB via the DTCH.

That is to say, the SS notifies the mobile terminal that the related service has been activated, the mobile terminal requests to establish the PTP RB according to the notification of the SS, and then the RB between the mobile terminal and the SS is established, the SS sends service to the mobile terminal through the RB.

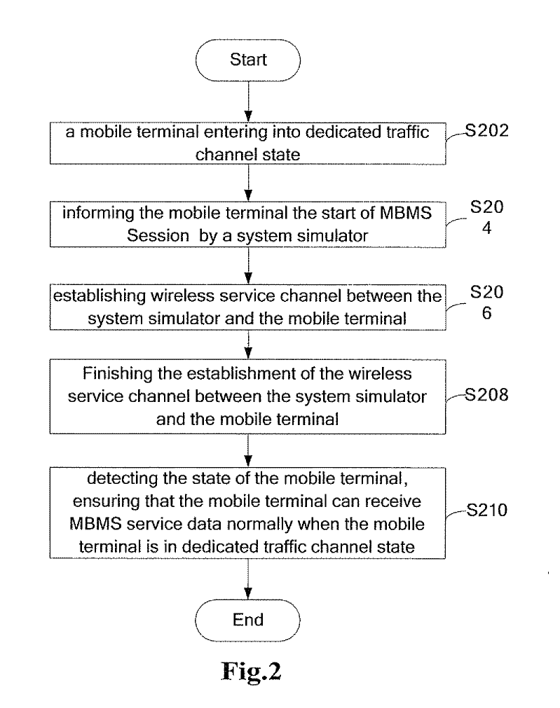

FIG. 2 shows the test method for a mobile terminal receiving MBMS service data according to the embodiment of the present invention. As shown in FIG. 2, the test method for a mobile terminal receiving MBMS service data includes the steps as follows: S202, the mobile terminal entering into dedicated traffic channel state; S204, the SS informing the start of an MBMS session; S206, establishing wireless service channel between the SS and the mobile terminal; S208, the establishment of the wireless service channel between the system simulator and the mobile terminal has been finished; and S210, testing the state of the mobile terminal to ensure that the mobile terminal is in dedicated traffic channel state and can receive MBMS service data normally.

Wherein, after step S208, the method further includes step S209, receiving MBMS service data transmitted by the system simulator via the wireless service channel by the mobile terminal.

Specifically, in the circumstance of the mobile terminal being in CELL_DCH state, the method for testing whether the mobile terminal can receive MBMS service transmitted in PTP mode after the notification information is received on the DCCH mainly comprises the following steps:

1) The mobile terminal enters into PS-DCCH+DTCH_DCH state (state 6-10) defined by 3GPP document TS 34.108.

2) The SS sends a MBMS MODIFIED SERVICES MESSAGE to the mobile terminal via the DCCH, and sets the information element “MBMS required UE, action” in the information to be “Request PTP RB”.

3) After receiving the MBMS MODIFIED SERVICES MESSAGE, according to the setting of the information element in the MESSAGE, the mobile terminal sends a MBMS MODIFICATION REQUEST MESSAGE to the SS to request to establish the RB required by service transmission.

4) After receiving the MBMS MODIFICATION REQUEST MESSAGE, the SS sends a RADIO BEARER SETUP MESSAGE to the mobile terminal to notify the mobile terminal to establish RB.

5) After establishing the RB between the mobile terminal and the SS, the mobile terminal sends a RADIO BEARER SETUP COMPLETE MESSAGE to notify the SS that the RB is successfully established.

6) The SS sends user data of the MBMS service through the newly established PTP RB.

7) The mobile terminal receives the MBMS service.

8) The state of the mobile terminal is detected to judge whether the mobile terminal is in CELL_DCH state or not. If the mobile terminal is in CELL_DCH state, it means the mobile terminal can receive the MBMS service transmitted in PTP mode and is in right state; otherwise, it means the test has failed.

Alternatively, in step 8, judging whether the MBMS service is received normally in step 7, if the MBMS service is received successfully in step 7 and the connection state of the mobile terminal detected in step 8 is the CELL_DCH state, the mobile terminal test is successful, otherwise, the ability test of the mobile terminal is failed.

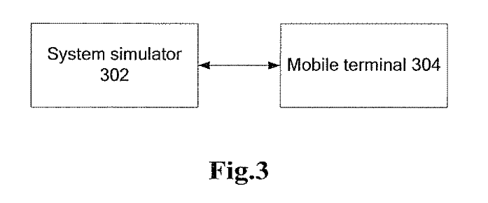

FIG. 3 shows the MBMS service transmitting system according to the embodiment of the present invention. As shown in FIG. 3, the MBMS service transmitting system comprises the SS 302 and the mobile terminal 304. Wherein, the SS 302 is used for establishing wireless service channel between the mobile terminal 304 and itself, and transmitting MBMS service data to the mobile terminal via the wireless service channel, detecting the state of the mobile terminal and ensuring the mobile terminal is in dedicated traffic channel state; and the mobile terminal 304 is used for establishing the wireless service channel between the SS 302 and itself, and receiving the MBMS service data transmitted by the SS via the wireless service channel.

Wherein, the SS detects the state of the mobile terminal to ensure that the mobile terminal is in dedicated traffic channel state and can receive MBMS service data normally.

The method provided by the present invention is easy and practical, and can test and verify the MBMS service ability of the mobile terminal properly.

The descriptions above are only preferable embodiments of the present invention, which are not used to restrict the present invention. For those skilled in the art, the present invention may have various changes and variations. Any amendments, equivalent substitutions, improvements etc. within the spirit and principle of the present invention are all concluded in the scope of protection of the present invention.

1. A method of a mobile terminal receiving MBMS service, wherein, the method includes the steps as follows:
S102, informing a mobile terminal the start of an MBMS session by a system simulator;
S104, transmitting the MBMS MODIFICATION SERVICE MESSAGE to the system simulator via a dedicated control channel DCCH by the mobile terminal to request the system simulator to establish a wireless service channel for point-to-point transmitting, the MBMS modified service information comprises information element;
S106, establishing the wireless service channel between the system simulator and the mobile terminal;
S108, receiving MBMS service data transmitted by the system simulator via the wireless service channel by the mobile terminal.

2. The method according to claim 1, wherein, the information element is requesting point-to-point wireless service channel.

3. A detection method for a mobile terminal to start an MBMS Session, wherein, the detection method includes the steps as follows:
S202, a mobile terminal entering into dedicated traffic channel state;
S204, informing the mobile terminal the start of an MBMS Session by a system simulator;
S206, establishing wireless service channel between the system simulator and the mobile terminal;
S208, Finishing the establishment of the wireless service channel between the system simulator and the mobile terminal;
S210, detecting the state of the mobile terminal, ensuring that the mobile terminal is in dedicated traffic channel state.

4. The method according to claim 3, wherein, after step S208, the method further includes step S209, receiving MEMS service data transmitted by the system simulator via the wireless service channel by the mobile terminal.

5. A MBMS service transmitting system, wherein, the MBMS service transmitting system comprises:
a system simulator, used for establishing wireless service channel between a mobile terminal and itself, and transmitting MBMS service data to the mobile terminal via the wireless service channel, detecting the state of the mobile terminal and ensuring the mobile terminal is in dedicated traffic channel state; and
the mobile terminal, used for establishing the wireless service channel between the system simulator and itself and receiving the MBMS service data transmitted by the system simulator via the wireless service channel.
